(19) United States
(12) Patent Application Publication
(10) Pub. No.: US 2023/0136171 A1
(43) Pub. Date: May 4, 2023

(54) Filter press beverage infuser with integrated grounds removal mechanism

(71) Applicant: Adam Zbinden, Kent, WA (US)

(72) Inventor: Adam Zbinden, Kent, WA (US)

(21) Appl. No.: 18/092,424

(22) Filed: Jan. 2, 2023

(51) Int. Cl. A47J 31/20; A47J 31/60

(52) U.S. Cl. CPC A47J 31/20; A47J 31/60

(57) ABSTRACT

A device for brewing coffee and other infused beverages according to the French press method, which provides the ability to stir the coffee grounds during brewing and remove the spent coffee grounds from the brewing vessel after liquid extraction, using the same mechanism required to remove the filter press assembly, which features a solid surface which extends beneath the filter assembly on a vertical arm which is coaxial with the vertical arm of the filter, and both solid surface and filter arms are manipulatable at the top of the device, using a handle and fastening mechanism, which allows an integrated stirring mechanism located on the solid arm to be rotated, and then the filter to be fully pressed down, while both arms, and the connected lower solid surface and upper filter surface, are removable simultaneously from the vessel after liquid is removed, which cleans the brewing vessel of coffee grounds during the action of filter removal.

### BACKGROUND OF THE INVENTION

A method of brewing coffee, commonly referred to in the existing art as a French press, involves the use of a filter and applied force to separate the solid coffee from the infused liquid. This form of coffee brewing has the advantages of simplicity and speed in preparation. A significant disadvantage of the process is the challenge of removing spent coffee grounds from the vessel after the coffee has been filter pressed and brewing is complete. Traditional methods require the use of a spoon or other implement to manually shovel the grounds from the vessel if they are to be removed.

### SUMMARY OF THE INVENTION

The present invention is a method for brewing coffee or other infused beverages which provides an integrated means for removing all spent coffee grounds and brewed material from the vessel using a means which includes the filter press assembly itself, and a surface situated beneath the filter surface and coffee beans and which connects axially to the filter press such that it can be removed along with the filter from the top of the vessel. The invention further incorporates a manual stirring function so the liquid can be stirred prior to pressing using the same handle location as that used for pressing.

### DESCRIPTION OF THE DRAWINGS

FIG. 1 is a side view of an embodiment of the present invention, when the vessel 1 has the surface 3 installed at the base of 1, and the arm 4 which connects to the surface 3 at end point 2 has an attached agitation surface shown with 11 which stirs the liquid when 4 is turned with the handle 9 connected at the arm connection point 10 via a swivel bushing mechanism installed at connection point 2 which allows 4 and 11 to rotate freely and independently with respect to 1 and 3.

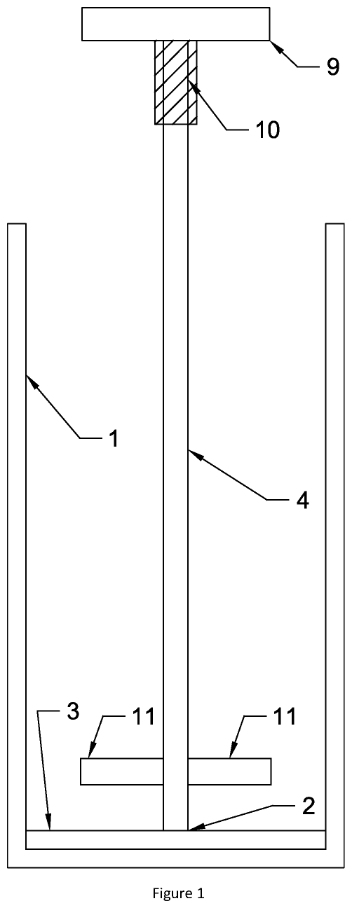

FIG. 2 is a side view of the hollow arm 7 and filter surface 5 which connect orthogonally at arm end point 6, where the handle 9 connects to the hollow arm at end point location 8 for use during manual pressing of top filter surface 5 toward bottom surface 3.

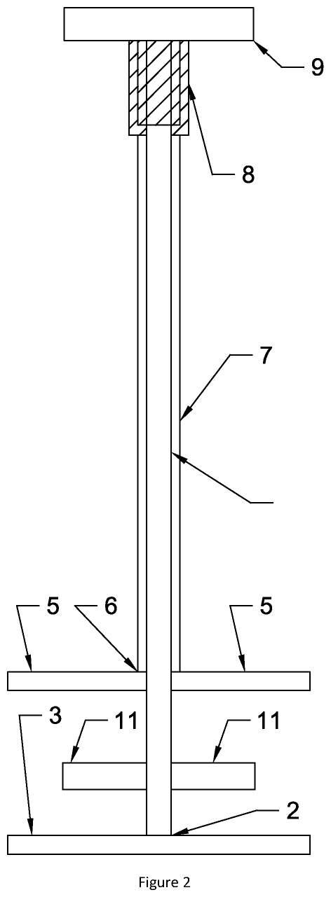

FIG. 3 is a profile view of the present invention, where 1 is the brewing vessel, 2 is the first end point of the first vertical force transfer arm 4, which connects in an orthogonal orientation at 2 to the bottom surface 3 which contains the spent coffee grounds, and 7 is the second vertical force transfer arm which connects at point 6 to the top filter surface 5, where 7 surrounds 4 concentrically such that 7 can be moved downward independently of 4 while 4 is stationary, and both force transfer arms 4 and 7 have integrated connection points shown with 10 and 8, respectively, which can be joined together with a fastening mechanism and handle shown with 9, such that the assembly comprised of bottom surface 3, inner force transfer member 4, top filter surface 5, and outer vertical force transfer arm 7 can be removed simultaneously from the vessel with a single force input to fastening mechanism and handle 9 via the connections of 8 and 10. arm 4 features agitation surfaces for liquid stirring, shown with 11, which can be rotated when the arm 4 is rotated with respect to the vessel 1 and surface 3 using the handle 9 at connection point 10, based on a bushing swivel connection at the end point 2 of arm 4.

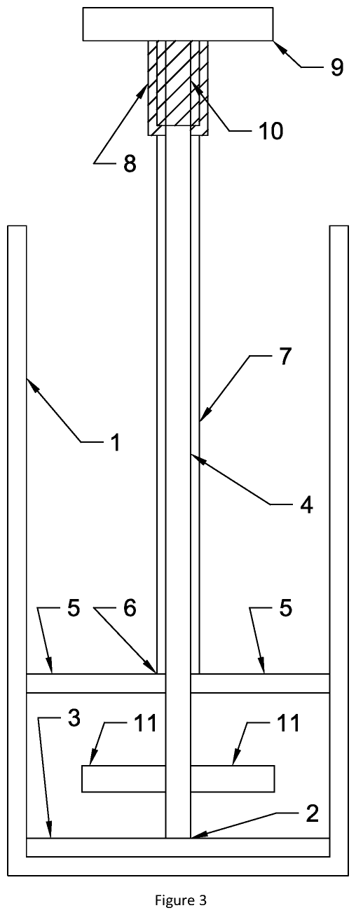

FIG. 4 is a top view of the present invention, showing the arrangement of vessel 1, top filter surface 5, force transfer arm 4, hollow force transfer arm 7, and handle 9, connection at endpoint locations 8 and 10.

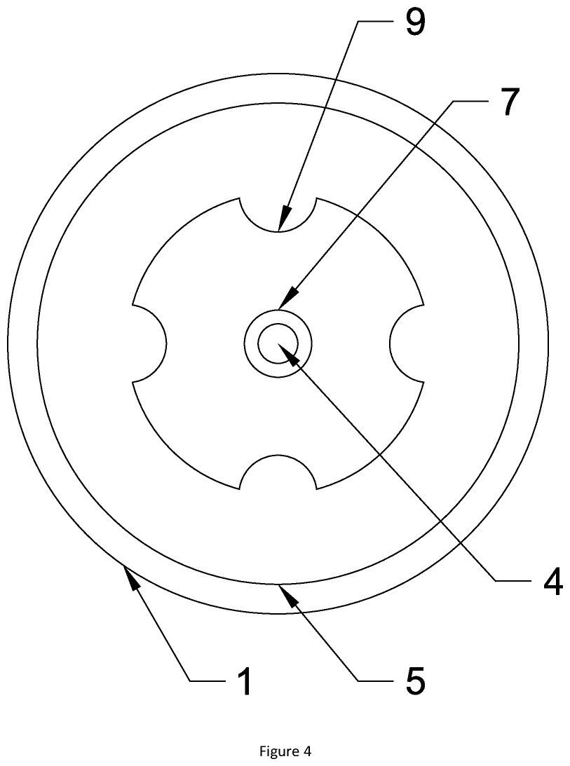

FIG. 5 is a profile view of the present invention, when the device is configured to manually filter press liquid.

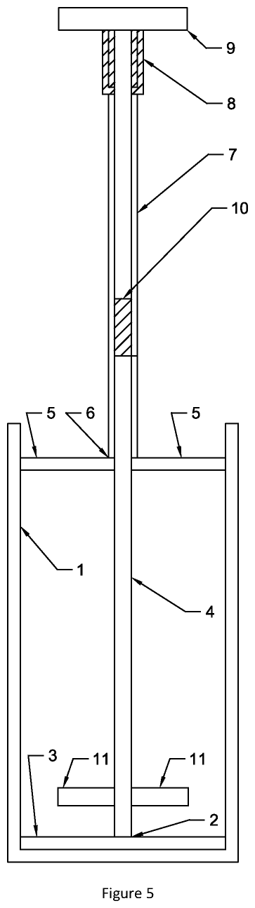

FIG. 6 shows the handle 9, and connection points 8 & 10 of the vertical force transfer arms 7 & 4, in a keyed configuration for fastening purposes.

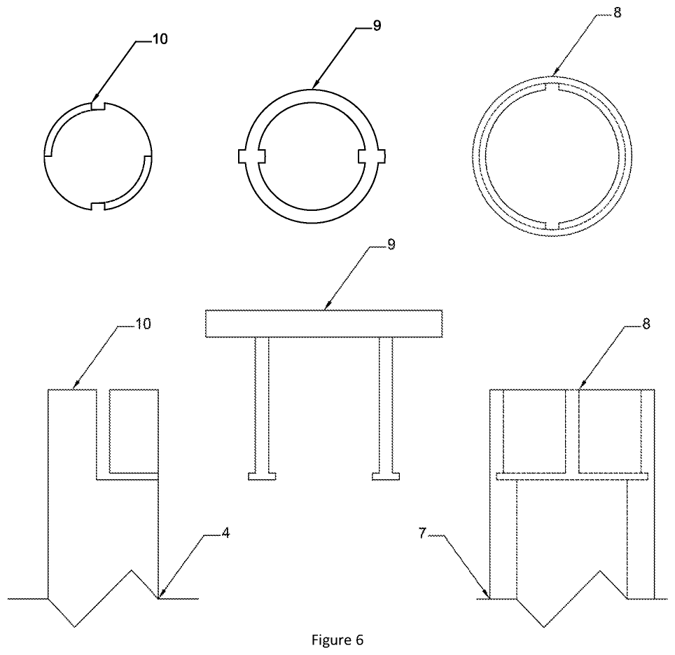

FIG. 7 shows a perspective view of the present invention.

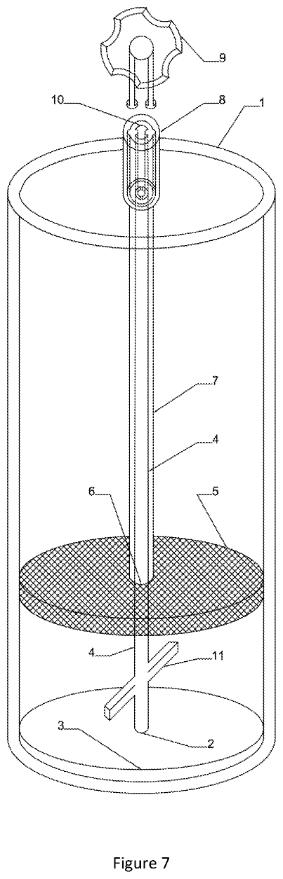

### DETAILED DESCRIPTION OF THE INVENTION:

To use the present invention, the first vertical force transfer arm 4 and attached surface 3 are inserted into the empty brewing vessel 1, such that the surface 3 is at the bottom of vessel 1.

Coffee grounds and hot water are added until the vessel 1 is filled.

The handle 9 is attached to force transfer arm 4 at connection point 10 and 4 is rotated with respect to vessel 1 and surface 3 about end point 2 using 9, which allows the agitating surfaces 11 to stir the liquid.

The second vertical force transfer arm 7 and attached filter surface 5 are placed concentrically around the first vertical force transfer arm 4, and the filter surface 5 is moved toward the surface 3 at the bottom of the vessel 1 via a downward force application to the fastening mechanism and handle 9 connected at location 8, which then joins the force transfer arms 4 & 7 at connection points 8 & 10 located at the top of the arms.

After the liquid is drained, and with arms 4 & 7 joined at their top connection locations 8 & 10, an upward force application to the fastening mechanism and handle 9 removes the filter and spent coffee grounds from the vessel 1.

Disconnecting arms 4 & 7 is performed by unfastening 9 from 8 & 10.

In the preferred embodiment of the present invention, the handle 9 and the connections points 8 & 10 of the force transfer arms 7 & 4 feature a keyed configuration as a method of fastening the components at the top of the device, but the handle 9 may also attach to the connection point 10 of the force transfer arm 4 with a screw, clamp, or other mechanical attachment means, and 9 may connect with 8, to enable the downward application of force through 7 when pressing the filter surface 5 via the handle 9, through physical contact between the two components, and 8 can be formed to contain 9 in a nested shell mating configuration.

The invention claimed is:

1. A device for infusing liquid beverages using a filter press, which provides an integrated mechanical means of removing infused material, the device comprising:
a vessel, comprised of a horizontal base and a plurality of vertically oriented walls, where said walls are connected to the horizontal base at a bottom location of the walls, and the vessel is open at a top location of said walls;
a bottom surface, with a center attachment point, and a surface perimeter configured to be adjacent the vessel walls;
a top filter surface, with a hollow center attachment point, and a filter surface perimeter configured to be adjacent the vessel walls;
a first vertical force transfer arm, connected orthogonally to the center attachment point of the bottom surface at a first end point, such that said arm is free to rotate independently on a horizontal plane, and featuring an integrated connection point at a second end point of said arm;
a second hollow vertical force transfer arm, connected orthogonally to the hollow center attachment point of the top filter surface at a first end point, and featuring an integrated connection point at a second end point, where said second hollow vertical force transfer arm concentrically surrounds the first vertical force transfer arm, and said arms can be moved independently along a common vertical axis;
wherein a first and second force transfer arm length is comprised of a linear distance between the first and second end points of said aims, with the second hollow force transfer arm length being of lesser magnitude than the first force transfer arm length, while the first force transfer arm extends from the base of the vessel to a plane above the top of the vessel walls, and a difference in length of the first and second arms creates a collection area for infused material, which is directly proportional in volume to said length difference, when the connection point of said second arm is level with, or beneath, the connection point of the first arm, when the first arm is vertically aligned within the hollow second arm;
one or more liquid agitating surfaces, attached to the first arm, at a location on the vertical axis of the first arm that is within the collection area for infused material, and
a fastening mechanism and handle, which attaches at the connection points of said vertical force transfer arms, to create a manual force application point for both vertical force transfer arms.
